(19) United States
(12) Patent Application Publication
(10) Pub. No.: US 2024/0343341 A1
(43) Pub. Date: Oct. 17, 2024

(54) MULTI-CONFIGURATION CYCLE

(71) Applicant: The Radio Flyer Company, Chicago, IL (US)

(72) Inventors: Collin Ostergaard, Chicago, IL (US); Jason Fitzwater, Chicago, IL (US)

(21) Appl. No.: 18/633,800

(22) Filed: Apr. 12, 2024

Related U.S. Application Data
(60) Provisional application No. 63/458,786, filed on Apr. 12, 2023.

(51) Int. Cl. B62M 3/08; B62J 1/08; B62J 9/14; B62K 3/02; B62K 5/06

(52) U.S. Cl. CPC B62M 3/08; B62J 1/08; B62J 9/14; B62K 3/02; B62K 5/06

(57) ABSTRACT

A cycle has a frame, a seat, a rear wheel, a front fork and handlebar, a front wheel rotatably secured to the front fork, and first and second pedals removably connected to the front wheel. The seat has a base, a top portion pivotally connected to the base to move between an open position and a closed position, and a cavity between the base and the top portion that is accessible when the top portion is in open position. The cavity has receivers that are sized to hold the first and second pedals after the first and second pedals are removed from the front wheel. The top portion can be moved to the closed position when the first and second pedals are in the receivers to store the first and second pedals in the cavity of the seat.

### DESCRIPTION

### CROSS-REFERENCE TO RELATED APPLICATIONS

This application claims the benefit of U.S. Provisional Patent Application No. 63/458,786 filed Apr. 12, 2023, which is expressly incorporated herein by reference and made a part hereof.

### FEDERALLY SPONSORED RESEARCH OR DEVELOPMENT

Not Applicable.

### TECHNICAL FIELD

The present subject matter relates to a multi-configuration cycle, and more particularly, to a multi-configuration tricycle with removable pedals and internal storage for the pedals.

### BACKGROUND

Bicycles and tricycles are known in the art. While such products according to the prior art provide a number of advantages, they nevertheless have certain limitations, especially when combined together. The present disclosure seeks to overcome certain of those limitations and other drawbacks of the prior art, and to provide new features not heretofore available. A full discussion of the features and advantages of the present disclosure is deferred to the following detailed description, which proceeds with reference to the accompanying drawings.

### SUMMARY

According to certain aspects of the present disclosure, the disclosed subject technology relates to cycles with removable pedals and internal storage for the pedals.

The disclosed technology further relates to a cycle, comprising: a frame; a rear leg pivot mechanism connected to the rear of the frame; first and second rear legs pivotally connected to the rear leg pivot mechanism; a first rear wheel connected to the first rear leg; a second rear wheel connected to the second rear leg, wherein the first and second rear wheels are pivotable with respect to the first and second rear legs to pivot the first and second rear wheels between a first inward position and a second outward position; a rear wheel pivot mechanism connecting the first rear wheel to the first rear leg, and another rear wheel pivot mechanism connecting the second rear wheel to the second rear leg, the pivot mechanisms allowing the rear wheels to independently pivot between the first inward position and the second outward position; a front fork connected to a front of the frame; a handlebar that operates the front fork; a front wheel rotatably secured to the front fork; first and second pedals removably connected to the front wheel; a release mechanism that releasably connects the first pedal to the front wheel, and another release mechanism that releasably connects the second pedal to the front wheel; and, a seat connected to the frame, wherein the seat comprises a base, a top portion pivotally connected to the base to move between an open position and a closed position, and a cavity between the base and the top portion that is accessible when the top portion is in open position, wherein the cavity has receivers that are sized to hold the pedals after the pedals are removed from the front wheel, and wherein the top portion can be moved to the closed position when the pedals are in the receivers to store the pedals in the cavity of the seat.

The disclosed technology further relates to a cycle, comprising: a frame; a first rear wheel connected to a rear of the frame; a front fork connected to a front of the frame; a handlebar that operates the front fork; a front wheel rotatably secured to the front fork; first and second pedals removably connected to the front wheel; and, a seat connected to the frame, wherein the seat comprises a base, a top portion pivotally connected to the base to move between an open position and a closed position, and a cavity between the base and the top portion that is accessible when the top portion is in open position, wherein the cavity has receivers that are sized to hold the first and second pedals after the first and second pedals are removed from the front wheel, and wherein the top portion can be moved to the closed position when the first and second pedals are in the receivers to store the first and second pedals in the cavity of the seat.

The disclosed technology further relates to a cycle, comprising: a frame; a first rear wheel connected to a rear of the frame; a front fork connected to a front of the frame; a handlebar that operates the front fork; a front wheel rotatably secured to the front fork; first and second pedals removably connected to the front wheel; a release mechanism that releasably connects the first pedal to the front wheel, and another release mechanism that releasably connects the second pedal to the front wheel; and, a seat connected to the frame, wherein the seat comprises a base, a top portion pivotally connected to the base to move between an open position and a closed position, and a cavity between the base and the top portion that is accessible when the top portion is in open position, wherein the cavity has receivers that are sized to hold the first and second pedals after the first and second pedals are removed from the front wheel, and wherein the top portion can be moved to the closed position when the first and second pedals are in the receivers to store the first and second pedals in the cavity of the seat.

The disclosed technology further relates to a cycle, wherein the first and second rear legs are pivotable from a first position to a second position, wherein in the first position the first and second rear legs are separated in a tricycle configuration, and wherein in the second position the first and second rear legs are together in a balance bike configuration.

The disclosed technology further relates to a cycle, wherein the rear leg pivot mechanism has a button that is used to release the first and second rear legs to allow the first and second rear legs to be moved between the first position and the second position.

The disclosed technology further relates to a cycle, wherein each release mechanism has a release lever and a bias member, wherein cach pedal has a hub, wherein a protrusion of the release lever mates with a groove of the hub to retain the hub within a bore of the front wheel.

The disclosed technology further relates to a cycle, wherein the release lever is moveable by a user to a second position to remove the protrusion from the groove of the hub to allow the hub of the pedal to be removed from the bore of the front wheel.

The disclosed technology further relates to a cycle, further comprising first and second rear legs, a second rear wheel, and a rear leg pivot mechanism connected to the rear of the frame, wherein the first and second rear legs are pivotally connected to the rear leg pivot mechanism, wherein the first and second rear legs are pivotable from a first position to a second position, wherein in the first position the first and second rear legs are separated in a tricycle configuration, and wherein in the second position the first and second rear legs are together in a balance bike configuration.

The disclosed technology further relates to a cycle, wherein the rear leg pivot mechanism has a button that is used to release the first and second rear legs to allow the first and second rear legs to be moved between the first position and the second position.

The disclosed technology further relates to a cycle, further comprising a second rear wheel, and first and second rear legs, wherein the first and second legs are connected to the frame, and wherein the first and second rear wheels are pivotable with respect to the first and second rear legs, respectively, to pivot the first and second rear wheels between a first inward position and a second outward position.

The disclosed technology further relates to a cycle, further comprising a rear wheel pivot mechanism connecting the first rear wheel to the first rear leg, and another rear wheel pivot mechanism connecting the second rear wheel to the second rear leg, the pivot mechanisms allowing the rear wheels to independently pivot between the first inward position and the second outward position.

The disclosed technology further relates to a cycle, further comprising a release mechanism that releasably connects the first pedal to the front wheel, and another release mechanism that releasably connects the second pedal to the front wheel.

The disclosed technology further relates to a cycle, wherein each release mechanism has a release lever and a bias member, wherein each pedal has a hub, wherein a protrusion of the release lever mates with a groove of the hub to retain the hub within a bore of the front wheel.

The disclosed technology further relates to a cycle, wherein the release lever is moveable by a user to a second position to remove the protrusion from the groove of the hub to allow the hub of the pedal to be removed from the bore of the front wheel.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present disclosure, it will now be described by way of example, with reference to the accompanying drawings in which embodiments of the disclosures are illustrated and, together with the descriptions below are incorporated in and constitute a part of this specification, and serve to explain the principles of the disclosure. In the drawings:

FIG. 1 is a rear top perspective view of a multi-configuration tricycle in a first use position, according to the present disclosure.

FIG. 2 is a partial front perspective view of a multi-configuration tricycle in a second use position, according to the present disclosure.

FIG. 3 is a partial front perspective view of a multi-configuration tricycle in a third use position, according to the present disclosure.

FIG. 4A is partial exploded perspective view of the multi-configuration tricycle, according to the present disclosure, showing a pedal exploded from the front wheel.

FIG. 4B is cross-sectional view about line 4B-4B of FIG. 4A, showing the cross section of the pedal insertion component.

FIG. 5 is a partial perspective view of a securing member for the pedal for the multi-configuration tricycle, in a normal use position, according to the present disclosure.

FIG. 6 is a partial perspective view of a securing member for the pedal for the multi-configuration tricycle, in an actuated position, according to the present disclosure.

FIG. 7 is a cross-sectional view of the securing member of FIG. 5 with the pedal inserted, according to the present disclosure.

FIG. 8 is a partial perspective view of the pedal compartment in the seat of the multi-configuration tricycle with the pedals removed, according to the present disclosure.

FIG. 9 is a partial perspective view of the pedal compartment in the seat of the multi-configuration tricycle with the pedals inserted, according to the present disclosure.

FIG. 10 is a partial perspective view of the seat of the multi-configuration tricycle of FIG. 9, with the pedals inserted into the pedal compartment in the seat and the seat closed, according to the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible of embodiments in many different forms, there is shown in the drawings and will herein be described in detail preferred embodiments with the understanding that the present disclosure is to be considered as an exemplification of the principles of the disclosure and is not intended to limit the broad aspect of the disclosure to the embodiments illustrated. It should be noted that the features illustrated in the drawings are not necessarily drawn to scale, and features of one embodiment may be employed with other embodiments as one of ordinary skill in the relevant art would recognize, even if not explicitly stated herein. Further, descriptions of well-known components and processing techniques may be omitted so as to not unnecessarily obscure the embodiments of the present disclosure. The examples used herein are intended merely to facilitate an understanding of ways in which the present disclosure may be practiced and to further enable those of ordinary skill in the art to practice the embodiments of the present disclosure. Accordingly, the examples and embodiments herein should not be construed as limiting the scope of the present disclosure, which is defined solely by the appended claims and applicable law.

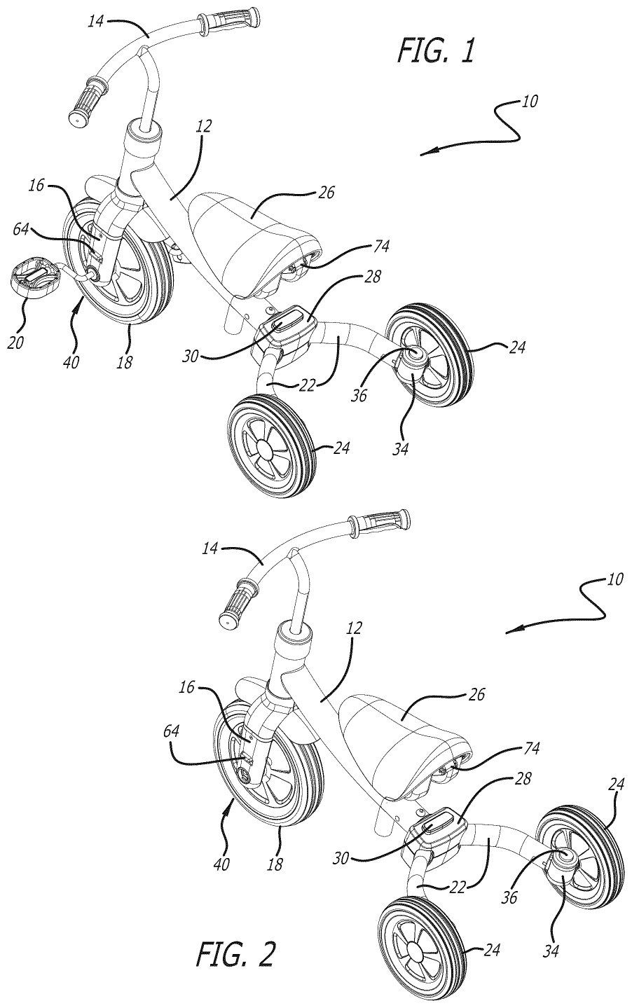

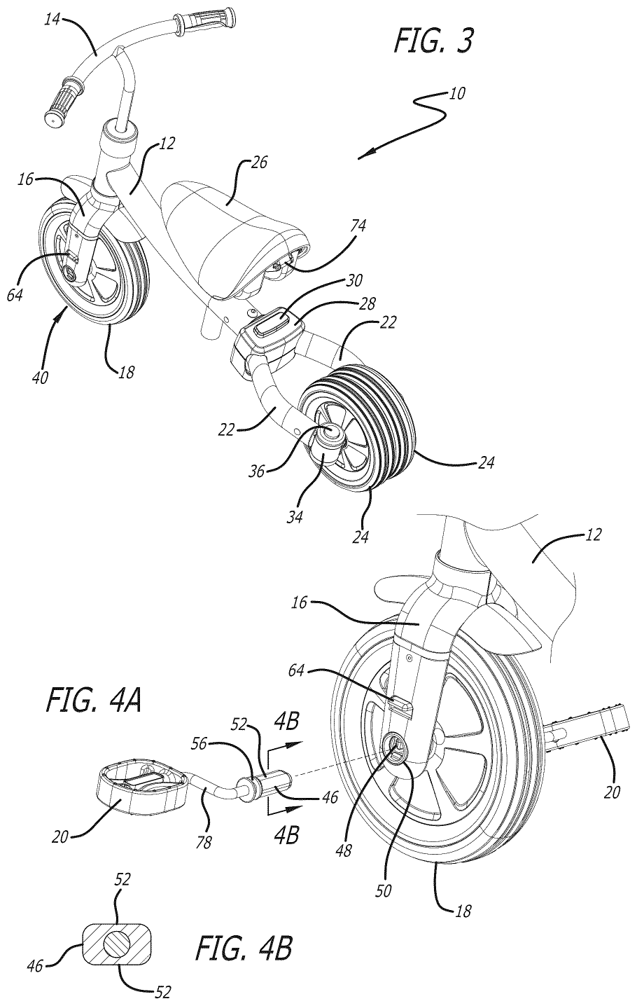

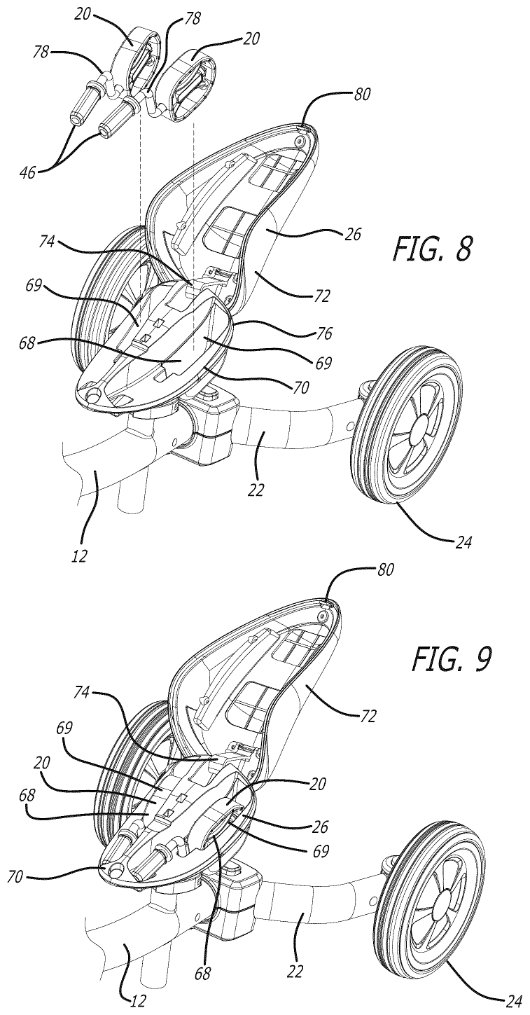

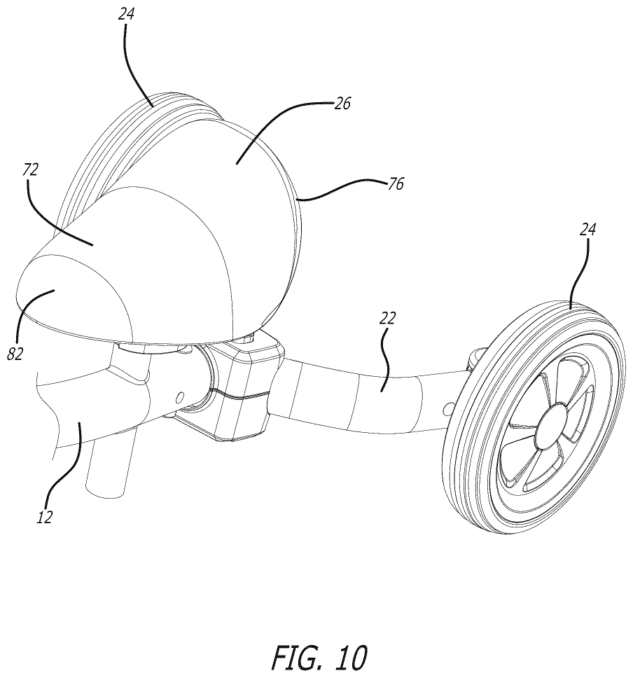

Generally, this disclosure describes several embodiments of a multi-configuration tricycle 10 that can be arranged in a variety of different orientations, both alone and in combination, and which have a variety of different functionality. In one orientation, as shown in FIG. 1, the multi-configuration tricycle 10 is configured in a tricycle mode as a tricycle with pedals for a child to pedal the tricycle. In a second orientation, as shown in FIG. 2, the multi-configuration tricycle 10 is configured in a ride-on mode as a tricycle with the pedals removed for a child to either be pushed or to push on the floor for movement. In a third orientation, as shown in FIG. 3, the multi-configuration tricycle 10 is configured in a balance bike mode with the pedals removed and the rear wheels rotated inwardly for a child to operate in a bicycle balance bike use. In various embodiments, the pedals are removable and can be stored in a compartment within the seat as shown in FIGS. 8-10.

Referring now to the figures, and initially to FIGS. 1-3, there is shown an embodiment of the multi-configuration cycle 10. The multi-configuration cycle 10, which in one embodiment is a tricycle, has a frame 12 with a handle bar 14 that operates a front fork 16, a front wheel 18 secured to the front fork 16, first and second pedals 20 for the front wheel 18, first and second rear legs 22 that secure, respectively, first and second rear wheels 24, and a seat 26. In an alternate embodiment, the product may be a bicycle, unicycle or other cycle having at least one wheel and a seat.

In one embodiment, the first and second rear legs 22 are pivotable from a first position, shown in FIGS. 1 and 2, to a second position, shown in FIG. 3. In the first position the rear legs 22 are separated and in a traditional tricycle configuration. In the second position the rear legs 22 are rotated inwardly to bring the rear wheels 24 together for a balance bike configuration. A rear leg pivot mechanism 28 at the rear of the frame 12 assists in pivoting the rear legs 22 between the first position and the second position. The rear leg pivot mechanism 28 has a button 30 that a user depresses. When the button 30 is depressed the rear legs 22 are released and can be moved/rotated from the first position to the second position and will snap in place in the second position, and similarly from the second position to the first position where they will snap in place in the first position. Specifically, in one embodiment, after the button 30 is depressed and the rear legs 22 are released, and once the button 30 is no longer depressed, the rear legs 22 will snap and lock in the appropriate position, either the first position or the second position based on user movement of the rear legs 22 following release of the button 30.

Further, the first and second rear wheels 24 are pivotable with respect to the rear legs 22, as shown in FIGS. 2 and 3. As shown in FIG. 2, each of the first and second rear wheels 24 can be positioned in a first or outward position where the rear wheels 24 are outside of the respective rear leg 22. A rear wheel pivot mechanism 34 is provided to assist in pivoting the rear wheels 24 to a second or inward position where the rear wheels 24 are inward of the respective rear leg 22 as shown in FIG. 3. Specifically, the rear wheel pivot mechanism 34 has a button 36 that releases the rear wheel 34 from its locked position, either inward or outward of the rear leg 22, and allows the user to pivot the wheel to the other of the inward or outward position where it will lock in place until the button 36 is again depressed. By allowing the rear wheels 24 to pivot between the outward and inward position the rear wheels 24 can be located next to one another and operate as a common rear wheel for the balance bike configuration as shown in FIG. 3.

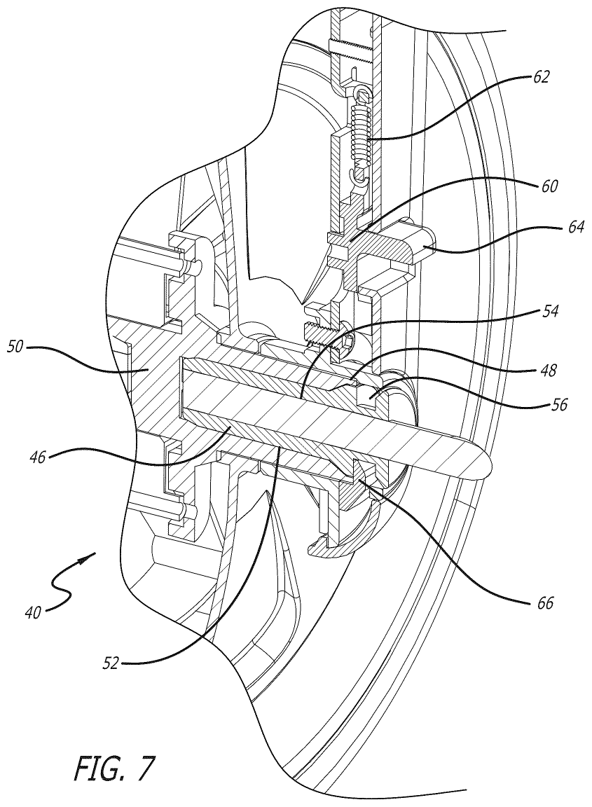

Referring to FIGS. 4A-7, the multi-configuration cycle 10 has two removable pedals 20 for the front wheel 18. The first and second pedals 20 are removably connected to the front wheel 18 via release mechanisms 40 on opposing sides of the front fork 16. In one embodiment, the first and second pedals 20 have a hub 46 that is inserted into a bore 48 of a bushing 50 that is mechanically connected to the front wheel 18. In one embodiment there maybe one bushing 50 for each side of the front wheel 18, however in alternate embodiments the same bushing 50 may be used for both sides. In one embodiment, as shown in FIG. 4B, the hub 46 has an external flat surface 52 that mates with an internal flat 54 in the bore 48 to ensure that the hub 46 is properly inserted into the bore 48 and that the mechanical force applied to the pedals 20 via the user is transferred to hub 46 to rotate the front wheel 18. The hub 46 also has an external groove 56 as shown in FIGS. 4A and 7.

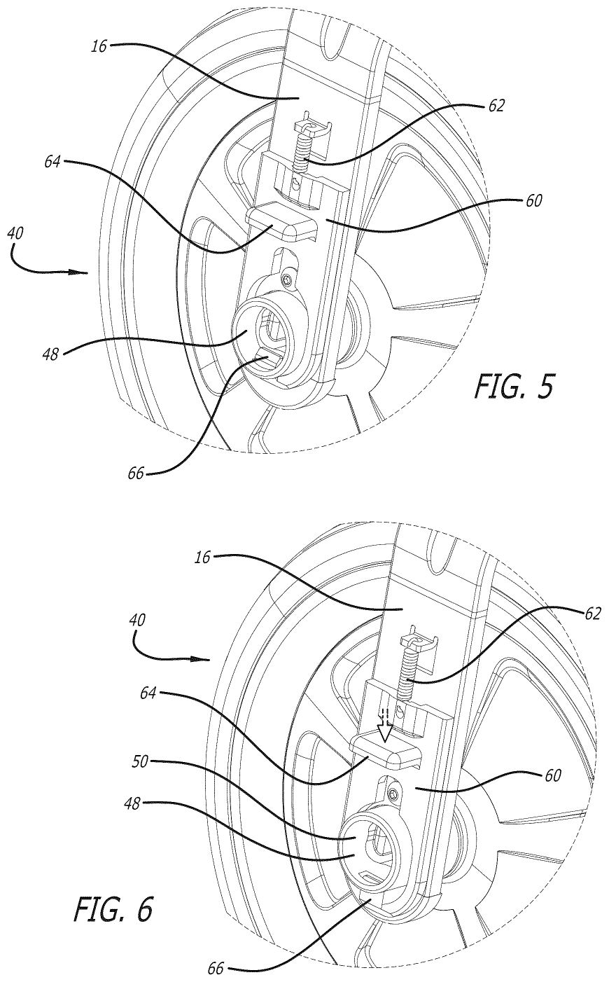

In one embodiment, each release mechanism 40 comprises a release lever 60 and a bias member 62. The bias member 62 is connected to the release lever 60 and biases the release lever to the unactuated position as shown in FIG. 5. The release lever 60 has an actuation tab 64 and a protrusion 66 that mates with the external groove 56 of the hub 46 of the pedal 20 to retain the hub 46 within the bore 48 until released by a user.

To connect each of the first and second pedals 20 to the bushing 50 of the front wheel 18 the user inserts the hub 46 into the bore 48 in the proper orientation such that the external flat surface 52 of the hub mates with the internal flat 54 in the bore 48. As the hub 46 is inserted into the bore 48 the force of the hub being inserted will push the release lever 60 by pushing the protrusion 66 down. When the hub 46 is inserted the appropriate distance the protrusion 66 will snap into the external groove 56 of the hub 46 via the force of the bias member 62 acting on the release lever 60, thereby locking the hub 46 and pedal 20 in place. The hub 46 and pedal 20 will remain connected to the bushing 50 until released by the user.

To remove each of the first and second pedals 30 from the bushing 50 of the front wheel 18 the user pushes down on the actuation tab 64 of the release lever 60. When the actuation tab 64 is pushed down the protrusion 66 will exit the external groove 56 of the hub 46 of the pedal 20 and allow the user to pull the hub 46 out of the bore 48. When the hub 46 is removed from the bore 48 the release lever 60 will return to its unactuated position via the force of the bias member 62.

As shown in FIGS. 8-10, once the first and second pedals 20 are removed, they may be stored in an internal cavity 68 within the seat 26. In one embodiment, the seat 26 comprises a base 70 and a top portion 72. The top portion 72 is connected to the base 70 via a hinge 74 at the rear 76 of the seat 26, and as such can be pivoted upward about the hinge 74 to expose the cavity 68 therein. The cavity 68 has receivers 69 that are sized and dimensioned to hold pedals 20, including the shaft 78 and the hub 46, after the first and second pedals are removed from the front wheel. Additionally, a connector 80 is provided adjacent the front 82 of the seat 26 so that when the top portion 72 of the seat 20 is pivoted downwardly to close the top portion 72 on the base 70, the top portion 72 is secured to the base 70. In this manner, when the multi-configuration tricycle 10 is configured in the ride-on mode shown in FIG. 2 or the balance bike mode shown in FIG. 3, the first and second pedals 20 are in the receivers 69 to store the first and second pedals 20 in the cavity 68 within the seat 26 for safe keeping and to prevent loss of the pedals 20.

The embodiments detailed hereinabove may be combined in full or in part, with any alternative embodiments described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim clement is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

It will be understood that the present disclosure may be embodied in other specific forms without departing from the spirit or central characteristics thereof. The present examples and embodiments, therefore, are to be considered in all respects as illustrative and not restrictive, and the Claims are not to be limited to the details given herein. Accordingly, while the specific embodiments have been illustrated and described, numerous modifications come to mind without significantly departing from the spirit of the disclosure and the scope of protection is only limited by the scope of the accompanying Claims.

Further, the claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A cycle, comprising:
a frame;
a rear leg pivot mechanism connected to the rear of the frame;
first and second rear legs pivotally connected to the rear leg pivot mechanism;
a first rear wheel connected to the first rear leg;
a second rear wheel connected to the second rear leg, wherein the first and second rear wheels are pivotable with respect to the first and second rear legs to pivot the first and second rear wheels between a first inward position and a second outward position;
a rear wheel pivot mechanism connecting the first rear wheel to the first rear leg, and another rear wheel pivot mechanism connecting the second rear wheel to the second rear leg, the pivot mechanisms allowing the rear wheels to independently pivot between the first inward position and the second outward position;
a front fork connected to a front of the frame;
a handlebar that operates the front fork;
a front wheel rotatably secured to the front fork;
first and second pedals removably connected to the front wheel;
a release mechanism that releasably connects the first pedal to the front wheel, and another release mechanism that releasably connects the second pedal to the front wheel; and, a seat connected to the frame, wherein the seat comprises a base, a top portion pivotally connected to the base to move between an open position and a closed position, and a cavity between the base and the top portion that is accessible when the top portion is in open position, wherein the cavity has receivers that are sized to hold the pedals after the pedals are removed from the front wheel, and wherein the top portion can be moved to the closed position when the pedals are in the receivers to store the pedals in the cavity of the seat.

2. The cycle of claim 1, wherein the first and second rear legs are pivotable from a first position to a second position, wherein in the first position the first and second rear legs are separated in a tricycle configuration, and wherein in the second position the first and second rear legs are together in a balance bike configuration.

3. The cycle of claim 2, wherein the rear leg pivot mechanism has a button that is used to release the first and second rear legs to allow the first and second rear legs to be moved between the first position and the second position.

4. The cycle of claim 1, wherein each release mechanism has a release lever and a bias member, wherein each pedal has a hub, wherein a protrusion of the release lever mates with a groove of the hub to retain the hub within a bore of the front wheel.

5. The cycle of claim 4, wherein the release lever is moveable by a user to a second position to remove the protrusion from the groove of the hub to allow the hub of the pedal to be removed from the bore of the front wheel.

6. A cycle, comprising:
a frame;
a first rear wheel connected to a rear of the frame;
a front fork connected to a front of the frame;
a handlebar that operates the front fork;
a front wheel rotatably secured to the front fork;
first and second pedals removably connected to the front wheel; and,
a seat connected to the frame, wherein the seat comprises a base, a top portion pivotally connected to the base to move between an open position and a closed position, and a cavity between the base and the top portion that is accessible when the top portion is in open position, wherein the cavity has receivers that are sized to hold the first and second pedals after the first and second pedals are removed from the front wheel, and wherein the top portion can be moved to the closed position when the first and second pedals are in the receivers to store the first and second pedals in the cavity of the seat.

7. The cycle of claim 6, further comprising first and second rear legs, a second rear wheel, and a rear leg pivot mechanism connected to the rear of the frame, wherein the first and second rear legs are pivotally connected to the rear leg pivot mechanism, wherein the first and second rear legs are pivotable from a first position to a second position, wherein in the first position the first and second rear legs are separated in a tricycle configuration, and wherein in the second position the first and second rear legs are together in a balance bike configuration.

8. The cycle of claim 7, wherein the rear leg pivot mechanism has a button that is used to release the first and second rear legs to allow the first and second rear legs to be moved between the first position and the second position.

9. The cycle of claim 6, further comprising a second rear wheel, and first and second rear legs, wherein the first and second legs are connected to the frame, and wherein the first and second rear wheels are pivotable with respect to the first and second rear legs, respectively, to pivot the first and second rear wheels between a first inward position and a second outward position.

10. The cycle of claim 9, further comprising a rear wheel pivot mechanism connecting the first rear wheel to the first rear leg, and another rear wheel pivot mechanism connecting the second rear wheel to the second rear leg, the pivot mechanisms allowing the rear wheels to independently pivot between the first inward position and the second outward position.

11. The cycle of claim 6, further comprising a release mechanism that releasably connects the first pedal to the front wheel, and another release mechanism that releasably connects the second pedal to the front wheel.

12. The cycle of claim 11, wherein each release mechanism has a release lever and a bias member, wherein each pedal has a hub, wherein a protrusion of the release lever mates with a groove of the hub to retain the hub within a bore of the front wheel.

13. The cycle of claim 12, wherein the release lever is moveable by a user to a second position to remove the protrusion from the groove of the hub to allow the hub of the pedal to be removed from the bore of the front wheel.

14. A cycle, comprising:
a frame;
a first rear wheel connected to a rear of the frame;
a front fork connected to a front of the frame;
a handlebar that operates the front fork;
a front wheel rotatably secured to the front fork;
first and second pedals removably connected to the front wheel;
a release mechanism that releasably connects the first pedal to the front wheel, and another release mechanism that releasably connects the second pedal to the front wheel; and,
a seat connected to the frame, wherein the seat comprises a base, a top portion pivotally connected to the base to move between an open position and a closed position, and a cavity between the base and the top portion that is accessible when the top portion is in open position, wherein the cavity has receivers that are sized to hold the first and second pedals after the first and second pedals are removed from the front wheel, and wherein the top portion can be moved to the closed position when the first and second pedals are in the receivers to store the first and second pedals in the cavity of the seat.

15. The cycle of claim 14, further comprising first and second rear legs, a second rear wheel, and a rear leg pivot mechanism connected to the rear of the frame, wherein the first and second rear legs are pivotally connected to the rear leg pivot mechanism, wherein the first and second rear legs are pivotable from a first position to a second position, wherein in the first position the first and second rear legs are separated in a tricycle configuration, and wherein in the second position the first and second rear legs are together in a balance bike configuration.

16. The cycle of claim 15, wherein the rear leg pivot mechanism has a button that is used to release the first and second rear legs to allow the first and second rear legs to be moved between the first position and the second position.

17. The cycle of claim 14, further comprising a second rear wheel, and first and second rear legs, wherein the first and second legs are connected to the frame, and wherein the first and second rear wheels are pivotable with respect to the first and second rear legs, respectively, to pivot the first and second rear wheels between a first inward position and a second outward position.

18. The cycle of claim 17, further comprising a rear wheel pivot mechanism connecting the first rear wheel to the first rear leg, and another rear wheel pivot mechanism connecting the second rear wheel to the second rear leg, the pivot mechanisms allowing the rear wheels to independently pivot between the first inward position and the second outward position.

19. The cycle of claim 14, wherein each release mechanism has a release lever and a bias member, wherein each pedal has a hub, wherein a protrusion of the release lever mates with a groove of the hub to retain the hub within a bore of the front wheel.

20. The cycle of claim 19, wherein the release lever is moveable by a user to a second position to remove the protrusion from the groove of the hub to allow the hub of the pedal to be removed from the bore of the front wheel.
